(19) United States
(12) Patent Application Publication
(10) Pub. No.: US 2017/0199579 A1
(43) Pub. Date: Jul. 13, 2017

(54) Gesture Control Module

(71) Applicants: Guo Chen, Shanghai (CN); Yang Li, Shanghai (CN); Gladys Yuen Yan Wong, Fremont, CA (US); James Armand Baldwin, Palo Alto, CA (US)

(72) Inventors: Guo Chen, Shanghai (CN); Yang Li, Shanghai (CN); Gladys Yuen Yan Wong, Fremont, CA (US); James Armand Baldwin, Palo Alto, CA (US)

(21) Appl. No.: 15/403,178

(22) Filed: Jan. 11, 2017

Related U.S. Application Data
(60) Provisional application No. 62/276,967, filed on Jan. 11, 2016.
(60) Provisional application No. 62/276,969, filed on Jan. 11, 2016.

(51) Int. Cl. G06F 3/01; G06K 9/00

(52) U.S. Cl. CPC G06F 3/017; G06K 9/00335

(57) ABSTRACT

A gesture-control interface is disclosed, comprising a camera, an infrared LED flash, and a processor that identifies the hand pose or the motion of the hand.

### CROSS-REFERENCE TO RELATED APPLICATIONS

The present application takes priority from Provisional App. No. 62/276,967, filed Jan. 11, 2016, and Provisional App. No. 62/276,969, filed Jan. 11, 2016, which are herein incorporated by reference.

### BACKGROUND

Field of the Invention

The present invention relates generally to user interface devices, and more specifically to touchless user interface devices that use hand gestures.

Background of the Invention

Humans have been using hand gestures to communicate for as long as there have been humans. The human hand is a versatile and highly expressive communication organ. As technology gets more and more omnipresent in our lives, the idea of using hand gestures to communicate with the various technological objects we use becomes more and more appealing.

There are some attempts to create a gesture interface to communicate with a computer or tablet. Such attempts tend to leverage the computer's power and resources to receive images of a person's hand, process those images, and interpret the person's gestures. However, all of this is very resource-intensive and takes up a lot of computing power.

A need exists for a gesture interface for simpler devices that have little or no computing power—light switches, lamps, appliances, and so on. While motion sensors are currently used for such devices, a motion sensor cannot communicate detailed information such as may be needed to operate an appliance or even a light with a dimmer switch. However, the no-touch nature of a motion sensor may be desirable for some applications—for example, in an operating room of a hospital where touch may compromise sterility.

### SUMMARY OF THE INVENTION

An object of the present invention is to provide a gesture interface for a device with minimal computing power that is self-contained, simple, and cheap.

Another object of the present invention is to provide a system and method for identifying hand positions and motions.

The method of the present invention preferably comprises illuminating a hand using a first frequency of light (preferably infrared), taking a first image of the hand using a camera, turning off illumination and taking a second image of the hand, subtracting the second image from the first image to obtain a clean image, and analyzing the clean image of the hand.

In an embodiment, the clean image of the hand is analyzed to determine the pose of the hand; this is preferably done by creating a classification tree to classify each hand pose according to at least one category and at least one subcategory, and then determining a category and subcategory for the clean image of the hand.

In an embodiment, the hand is illuminated again and a third image is taken; then the illumination is turned off and a fourth image is taken. The fourth image is subtracted from the third image to produce a second clean image of the hand. Both the clean image of the hand and the second clean image of the hand are then processed using an adaptive threshold to generate a shape, and circles are inscribed into the shape. The circles are preferably greater in diameter than a predetermined number. Then, the first shape is subtracted from the second shape, and all the circles are overlaid on top of the image. Each circle is evaluated for whether or not it contains any non-black pixels. If at least one circle containing only black pixels is below the difference image, the system concludes that the hand is moving up; if it is above the difference image, the hand is moving down; if it is to the left of the difference image, the hand is moving to the right; and if it is to the right of the difference image, the hand is moving to the left.

In an embodiment, the system also evaluates the distance between the difference image and the furthest circle containing only black pixels. That is used to estimate the speed of motion of the hand.

In an embodiment, the steps are repeated to generate a trajectory for the hand.

In the preferred embodiment, the first frequency of light is infrared and the camera is an infrared camera.

In an embodiment, the illumination is turned on and off at a regular frequency of 120 Hz and the camera takes images at a regular frequency of 240 Hz.

In an embodiment, the image is cropped to just the image of the hand to remove unnecessary blank space. This is preferably done by using an adaptive filter to binary the image, determining pixel intensity in the image, and cropping the image to just the rectangular area where pixel intensity is nonzero.

The results of the analyzing step may be used to control any device; examples include a light switch, a music player, a toilet, a water faucet, a shower, a thermostat, or medical equipment.

A system of the present invention preferably comprises a camera, a light source, and a processor that performs the above functions.

### LIST OF FIGURES

FIG. 1 shows a block diagram of an embodiment of the present invention.

FIG. 2 shows a timing diagram of the flash and camera trigger patterns.

FIG. 3 shows an embodiment of the process of subtracting the background from the image of the hand.

FIG. 4 shows an embodiment of the process of cropping the image.

FIG. 5 shows a sample classification tree for identifying a hand pose.

FIG. 6 shows an illustration of the process for identifying the direction of motion of the hand.

### DETAILED DESCRIPTION OF THE PREFERRED EMBODIMENT

Several embodiments of the present invention are described below. It will be understood that the present invention encompasses all reasonable equivalents to the below-described embodiments, as is evident to a person of reasonable skill in the art.

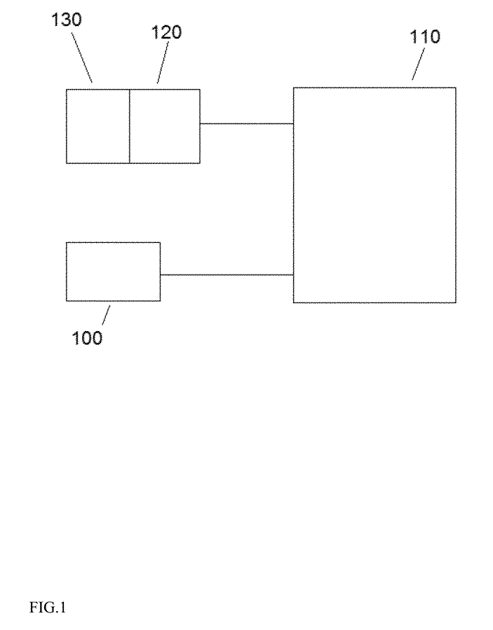

A block diagram of an embodiment of the system of the present invention is shown in FIG. 1. An infrared LED 100 is connected to a processor 110. An infrared camera 120 with an infrared filter 130 is also connected to the processor. The camera is preferably of sufficient quality to produce an image of a human hand at a distance of up to 1 meter from the camera. Preferably, the camera is an Omnivision OV6211, which is a 10 bit monochrome camera with a 400 by 400 resolution (0.16Megapixel) CMOS sensor and combined with a 1/10.5″ lens. The infrared LED is preferably an 850 nm LED similar to an OSLON SFH4710.

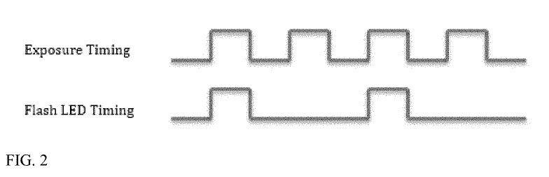

In the preferred embodiment, the infrared LED flashes on and off at regular intervals, and the camera is triggered to take a photographic image of the hand with and without the infrared illumination. FIG. 2 shows a diagram of the way this occurs. For every cycle, the camera therefore produces two images—one with the hand illuminated by the LED and one without the illumination. The images are preferably taken close enough together that there is no appreciable movement of the hand between the two images. In the preferred embodiment, the LED is triggered to flash at a frequency of 60 Hz, while the camera is triggered to take images at a frequency of 120 Hz. However, any other frequency or irregular intervals may be used as long as the image of the hand with IR illumination and the image of the hand without IR illumination are taken close enough together that there is no appreciable movement of the hand between the two.

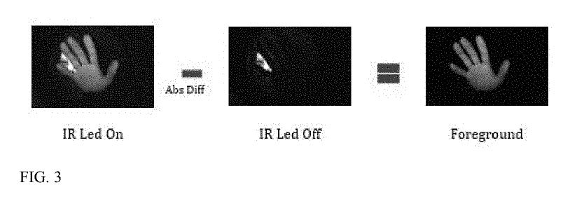

After the two images are taken (one with IR illumination and one without), the processor preferably subtracts one image from the other to remove the background. FIG. 3 shows an example of how this is done. After the subtraction is done, a clean image is obtained.

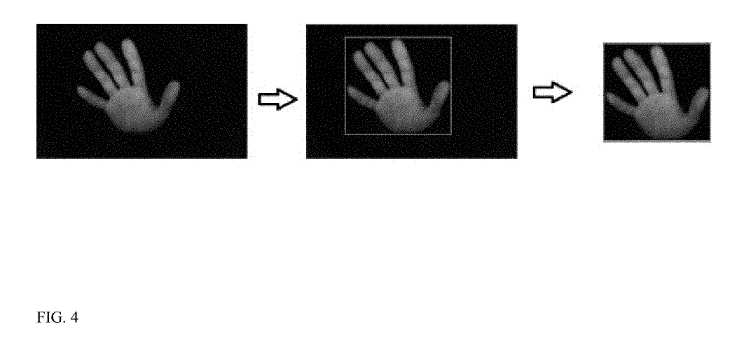

In an embodiment, the image is cropped to remove extraneous blank space and to save memory. This is preferably done in a manner shown in FIG. 4. An adaptive filter is used to binary the image. Then, the processor determines the pixel intensity in the image. The image is then cropped to just the rectangular area where pixel intensity is nonzero, as shown in the Figure.

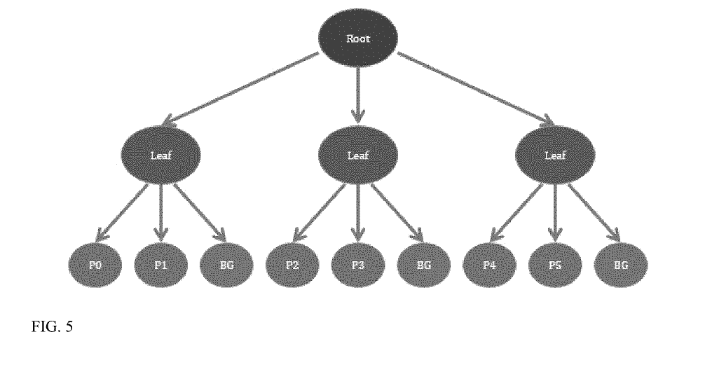

The image is then analyzed to interpret the position or motion of the hand. In one embodiment, the static hand pose is identified. For example, the hand pose could be a fist, an open palm, a thumbs-up sign, and so on. To identify the hand pose, the shape of the hand is compared with images of various hand poses stored in memory. In one embodiment, the images stored in memory are classified according to at least one classification and at least one sub-classification to form a classification tree. For example, some classifications could be “open hand”, “closed hand” —then the “open hand” poses could be further classified into “palm forward” or “palm back” and the “closed hand” poses could be further classified into “thumb out” or “thumb in”, and so on. FIG. 5 shows a sample decision tree.

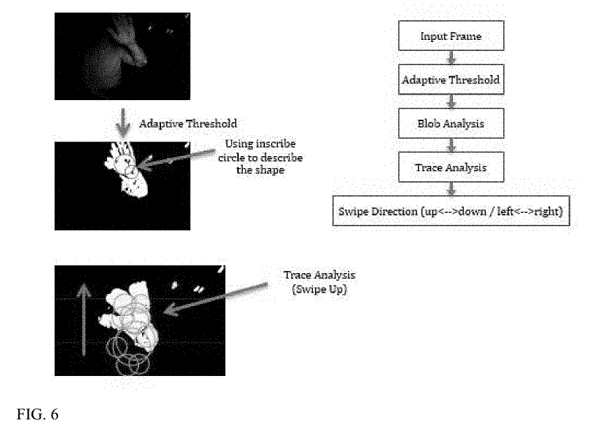

In an alternate embodiment, the motion of the hand is identified. This embodiment is illustrated in FIG. 6. For that, at least two consecutive images of the hand are used. For each image, a “blob analysis” is performed. The image is binaried as shown in the Figure, and then circles are inscribed into the white shape as shown. In the preferred embodiment, the circles are constrained to have a diameter above a certain predetermined minimum—i.e. if a circle of the minimum diameter cannot fit into a particular location of the shape, it is not drawn.

After a blob analysis is performed on each image, the two images are subtracted from each other and all the circles are overlaid on the resulting image. This is known as trace analysis. The processor then looks for circles that are empty and circles that are partially filled and circles that are entirely filled. The relative locations and distances of the empty circles and the partially or entirely filled circles is what determines the speed and direction of motion of the hand. In the example shown in the Figure, the empty circles are below the filled circles; this means that the hand is moving upward.

In an embodiment, only the four cardinal directions (up, down, left, right) can be determined. In another embodiment, the system can also evaluate the angle at which the hand is moving, calculating the “center of mass” of the sum total of the empty circles and the “center of mass” of the sum total of the filled or partially filled circles.

In an embodiment, the speed of motion of the hand is also determined. This is estimated based on the distance between the furthest empty circle from the filled or partially filled circle.

The applications of the present invention can be numerous. For example, a user could turn on a water faucet with a hand gesture, and change the water temperature with another hand gesture. A user could use a hand gesture to turn on a music player and another hand gesture to control its volume. A hand gesture could be used to flush a toilet and different hand gestures could be used to trigger the toilet to perform other functions, such as bidet functions, heating the seat, air-drying functions, and so on. In a hospital setting, different hand gestures could be used to control various medical equipment without touching it and thus compromising sterility. Due to the present invention's simplicity, it could be built into a device easily without increasing its footprint or energy usage, or it could be a separate standalone module that could be connected to a device wirelessly or by a cable.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled”, however, may also mean that two or more elements are not in direct contact with each other, but yet still co-operate or interact with each other. The embodiments are not limited in this context.

As used herein, the terms “comprises”, “comprising”, “includes”, “including,” “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of ordinary skill in the art will appreciate still additional alternative structural and functional designs through the disclosed principles of the embodiments. Thus, while particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

1. A method for recognizing hand gestures, comprising:
illuminating a hand using a first frequency of light;
taking a first image of the hand using a camera;
turning off illumination with the first frequency of light;
taking a second image of the hand using the camera;
subtracting the second image from the first image to obtain a clean image of the hand;
analyzing the clean image of the hand.

2. The method of claim 1, where the analyzing step comprises identifying a hand pose shown in the clean image of the hand.

3. The method of claim 2, where the analyzing step comprises:
creating a library of hand poses;
creating a classification tree to classify each hand pose according to at least one category and at least one subcategory for each of the at least one category;
identifying a category for the clean image of the hand;
identifying a subcategory for the clean image of the hand;
identifying a hand pose shown in the clean image of the hand based on the category and the subcategory.

4. The method of claim 1, where the analyzing step comprises identifying a location for the hand shown in the clean image of the hand, further comprising:
turning on illumination with the first frequency of light;
taking a third image of the hand using the camera;
turning off illumination with the first frequency of light;
taking a fourth image of the hand using the camera;
subtracting the fourth image from the third image to obtain a second clean image of the hand;
comparing the clean image of the hand to the second clean image of the hand to determine the direction and speed of motion of the hand.

5. The method of claim 4, wherein the comparing step comprises:
processing the clean image of the hand using an adaptive threshold to generate a shape;
inscribing circles into the shape until the shape is covered;
processing the second clean image of the hand using an adaptive threshold to generate a second shape;
inscribing circles into the second shape until the second shape is covered;
subtracting the first shape from the second shape to generate a difference image;
overlaying all the circles onto the difference image;
determining which circles contain non-black pixels and which circles only contain black pixels;
if at least one circle containing black pixels is below the difference image, concluding that the hand is moving up;
if at least one circle containing black pixels is above the difference image, concluding that the hand is moving down;
if at least one circle containing black pixels is to the left of the difference image, concluding that the hand is moving to the right;
if at least one circle containing black pixels is to the right of the difference image, concluding that the hand is moving to the left.

6. The method of claim 5, further comprising:
determining the distance between the difference image and the furthest circle containing black pixels;
using the distance to estimate the speed of motion of the hand.

7. The method of claim 5, further comprising:
repeating the steps at least once to generate a trajectory for the hand.

8. The method of claim 1, wherein the first frequency of light is infrared and where the camera is an infrared camera.

9. The method of claim 1, wherein the steps of illuminating and turning off illumination are repeated at a frequency of 120 Hz.

10. The method of claim 1, further comprising:
after subtracting the second image from the first image, using an adaptive threshold method to binary the image;
determine pixel intensity in the image;
determine the longest vertical range where the pixel intensity is nonzero;
determine the longest horizontal range where the pixel intensity is nonzero;
cropping the image to the longest vertical range and the longest horizontal range.

11. The method of claim 1, further comprising:
using a result of the analyzing step to control one of the following: a light switch, a music player, a toilet, a water faucet, a shower, a thermostat, medical equipment.

12. A system for controlling a device, said system comprising:
a camera;
a light source;
a processor connected to the camera and to the light source, said processor configured to perform the following steps:
illuminating a hand using a first frequency of light;
taking a first image of the hand using a camera;
turning off illumination with the first frequency of light;
taking a second image of the hand using the camera;
subtracting the second image from the first image to obtain a clean image of the hand;
analyzing the clean image of the hand.

13. The system of claim 12, wherein the light source emits infrared light and where the camera is an infrared camera.

14. The system of claim 12, wherein the light source is turned on and off at a frequency of 120 Hz.

15. The system of claim 12, wherein the processor is further configured to perform the following actions:
after subtracting the second image from the first image, using an adaptive threshold method to binary the image;
determine pixel intensity in the image;
determine the longest vertical range where the pixel intensity is nonzero;
determine the longest horizontal range where the pixel intensity is nonzero;
cropping the image to the longest vertical range and the longest horizontal range.

16. The system of claim 12, wherein the processor is configured to perform the following actions to analyze the clean image of the hand:
creating a library of hand poses;
creating a classification tree to classify each hand pose according to at least one category and at least one subcategory for each of the at least one category;
identifying a category for the clean image of the hand;
identifying a subcategory for the clean image of the hand;
identifying a hand pose shown in the clean image of the hand based on the category and the subcategory.

17. The system of claim 12, where the processor is configured to perform the following actions to analyze the clean image of the hand:
turning on illumination with the first frequency of light;
taking a third image of the hand using the camera;
turning off illumination with the first frequency of light;
taking a fourth image of the hand using the camera;
subtracting the fourth image from the third image to obtain a second clean image of the hand;
comparing the clean image of the hand to the second clean image of the hand to determine the direction and speed of motion of the hand.

18. The system of claim 17, where the processor is configured to perform the following actions to compare the clean image of the hand to the second clean image of the hand:
processing the clean image of the hand using an adaptive threshold to generate a shape;
inscribing circles into the shape until the shape is covered;
processing the second clean image of the hand using an adaptive threshold to generate a second shape;
inscribing circles into the second shape until the second shape is covered;
subtracting the first shape from the second shape to generate a difference image;
overlaying all the circles onto the difference image;
determining which circles contain non-black pixels and which circles only contain black pixels;
if at least one circle containing black pixels is below the difference image, concluding that the hand is moving up;
if at least one circle containing black pixels is above the difference image, concluding that the hand is moving down;
if at least one circle containing black pixels is to the left of the difference image, concluding that the hand is moving to the right;
if at least one circle containing black pixels is to the right of the difference image, concluding that the hand is moving to the left.

19. The system of claim 18, further comprising:
determining which circle containing black pixels is the furthest from the difference image;
evaluating a distance between the furthest circle containing black pixels and the difference image;
using the distance to estimate a speed of the hand.
